(19) United States
(12) Patent Application Publication
(10) Pub. No.: US 2015/0348041 A1
(43) Pub. Date: Dec. 3, 2015

(54) FRAUD SCORING METHOD AND SYSTEM FOR USE WITH PAYMENT PROCESSING

(71) Applicant: Bottomline Technologies (DE) Inc., Portsmouth, NH (US)

(72) Inventors: Eric Campbell, Rye, NH (US); Nicole Pierrette Dwyer, Dover, NH (US); Dean Jenkins, Brunswick, OH (US); Zarir Sidhwa, Westborough, MA (US); Steven Wayne Rubenstein, North Woodmere, NY (US); Gina Robins, Dover, NH (US); Evan Michael Lerch, Portsmouth, NH (US)

(73) Assignee: Bottomline Technologies (DE) Inc., Portsmouth, NH (US)

(21) Appl. No.: 14/293,512

(22) Filed: Jun. 2, 2014

(51) Int. Cl. G06Q 20/40

(52) U.S. Cl. CPC G06Q 20/4016

(57) ABSTRACT

A method and payment processing system are presented for verifying a requested action for payment processing. Before executing the requested action, the system sends a request for a fraud score and determines an interface mode of the requested action. The system processes the requested action according to the determined interface mode and, if received, a fraud score.

### TECHNICAL FIELD

The present invention relates to a payment processing system, more particularly, to a method and system for verifying the authenticity of actions submitted by third parties to the payment processing system.

### BACKGROUND OF THE INVENTION

Businesses are increasingly using electronic payment processing systems to handle invoice payments. Current systems allow multiple users associated with a corporate customer to make payments, authorize payments, change account information associated with payees, etc. The number of individuals involved with the invoice payment process, as well as the vast number of invoices processed by electronic payment processing systems, makes it difficult to detect fraudulent payments.

Current fraud detection systems analyze the identity of the payee (i.e., the party receiving payment) to detect fraud. More robust methods are needed to detect and prevent fraud without reducing the efficiency of the payment processing system.

### SUMMARY OF THE INVENTION

The present invention provides a fraud scoring method for verifying a requested action for payment processing and allowing management of fraud risk against transaction execution risk.

According to one aspect of the disclosure, there is provided a fraud scoring method for verifying a requested action for payment processing and allowing management of fraud risk against transaction execution risk. The method includes receiving the requested action from a user and requesting a fraud score for the requested action, wherein the fraud score is allow action, block action, deny action, challenge action, allow and delay action, or deny and delay action. The method also includes assigning an interface mode for processing the requested action. The interface mode is either synchronous mode or asynchronous mode and whether the interface mode is synchronous mode or asynchronous mode is determined by analyzing the requested action. The method additionally includes, if the interface mode of the requested action is synchronous mode, refusing to accept further requested actions from the user until the fraud score for the requested action is received and if no fraud score is received after a period of time greater than a synchronized cutoff time threshold, changing the interface mode for the requested action to asynchronous mode or assigning the fraud score of the requested action to be allow and delay action or deny and delay action. The method further includes, if the interface mode of the requested action is asynchronous mode, allowing the user to submit further requested actions before the fraud score for the requested action is received and if no fraud score is received after a period of time greater than an asynchronous cutoff time threshold, assigning the fraud score of the requested action to be an asynchronous default fraud score. If the fraud score assigned to the requested action is allow action, then the requested action is performed. If the fraud score assigned to the requested action is block action or deny action, applying a final status of rejected to the requested action such that the requested action is not performed. If the fraud score assigned to the requested action is challenge action, requesting a new fraud score for the requested action. If the fraud score assigned to the requested action is allow and delay action, the method allows the user to submit further requested actions before the fraud score for the requested action is received and delays performing the requested action until an additional fraud score is received or, if no additional fraud score is received after a period of time greater than an allow and delay time threshold, setting the requested action to be performed. If the fraud score assigned to the requested action is deny and delay action, the method allows the user to submit further requested actions before the fraud score for the requested action is received and delays performing the requested action until another fraud score is received or, if another fraud score is not received after a period of time greater than a deny and delay time threshold, applying a final status of rejected to the requested action such that the requested action is not performed.

Alternatively or additionally, the interface mode for processing the requested action is determined by analyzing an action type of the requested action and a payment type of the requested action.

Alternatively or additionally, the interface mode of the requested action is determined using an interface configuration table and the action type and/or the payment type.

Alternatively or additionally, the action type is either a payment or a template. Alternatively or additionally, the payment type is either Faster Payment, Wire, CHAPS, BAGS, or file.

Alternatively or additionally, the interface mode of the action is determined using an interface configuration table.

Alternatively or additionally, the asynchronous default fraud score is allow action, block action, deny action, allow and delay action, deny and delay action, or challenge action.

Alternatively or additionally, the delay default fraud score is allow action or block action.

Alternatively or additionally, the synchronous cutoff time threshold is 5000 seconds.

Alternatively or additionally, the asynchronous cutoff time threshold is 15 minutes and the delay cutoff timeout is 15 minutes or 30 minutes.

Alternatively or additionally, if the requested action is one action in a set of actions included in an imported file, then the interface mode for the requested action is set to be asynchronous mode and the asynchronous cutoff time threshold is extended to a file import timeout buffer that is greater than the asynchronous cutoff time threshold.

Alternatively or additionally, the file import timeout buffer is one hour.

Alternatively or additionally, if the fraud score assigned to the requested action is deny action, the final status of rejected is applied to the requested action such that the requested action is not performed unless authorized by another user.

Alternatively or additionally, the requested action is related to a payment request and, if the fraud score assigned to the requested action is block action, the final status of rejected is applied to the related payment request such that the related payment request is not advanced for payment processing.

Alternatively or additionally, the requested action is related to a payment request and payment requests are released to a financial institution or a clearing system at a payment release time. A cutoff release threshold is a period of time prior to the payment release time In which users are not permitted to send new requested actions. If the fraud score assigned to the requested action is allow and delay action, another fraud score is not received, and the cutoff release threshold has been exceeded, setting the requested action to be performed. If the fraud score assigned to the requested action is deny and delay action, another fraud score is not received, and the cutoff release threshold has been exceeded, applying a final status of rejected to the requested action such that the requested action is not performed.

According to one aspect of the disclosure, there is provided a payment processing system for verifying a requested action for payment processing and allowing management of fraud risk against transaction execution risk. The system includes a processor and a network interface communicatively coupled. The network interface is configured to receive at least one requested action from a user and for each received requested action: sends a request for a fraud score for the requested action, wherein the fraud score is allow action, block action, deny action, challenge action, delay action, allow and delay action, or deny and delay action; and when the fraud score for the requested action is received, notify the processor. The processor configured to, for each received requested action: to assign an interface mode for processing the requested action, wherein the interface mode is either synchronous mode or asynchronous mode and whether the interface mode is synchronous mode or asynchronous mode is determined by analyzing the requested action. If the interface mode of the requested action is synchronous mode, the processor is configured to notify the network interface to refuse to accept further requested actions from the user until the fraud score for the requested action is received and if no fraud score is received by the network interface after a period of time greater than a synchronized cutoff time threshold, change the interface mode for the requested action to asynchronous mode or assign the fraud score of the requested action to be allow and delay action or deny and delay action. If the interface mode of the requested action is asynchronous mode, the processor is configured to notify the network interface to accept further requested actions submitted by the user before the fraud score for the requested action is received and, if no fraud score is received after a period of time greater than an asynchronous cutoff time threshold, assign the requested action an asynchronous default fraud score. If the fraud score is received by the network interface for the requested action, the processor is configured to assign the fraud score to the requested action. If the fraud score assigned to the requested action is allow action, the processor enables the requested action to be performed. If the fraud score assigned to the requested action is block action or deny action, the processor applies a final status of rejected to the requested action such that the requested action is not performed. If the fraud score assigned to the requested action is challenge action, the processor is configured to notify the network interface to request a new fraud score for the requested action. If the fraud score assigned to the requested action is allow and delay action, the processor is configured to notify the network interface to accept any further requested actions submitted by the user before the fraud score for the requested action is received, delay performing the requested action until an additional fraud score is received, and, if the additional fraud score is not received after a period of time greater than an allow and delay time threshold, the processor enables the requested action to be performed. If the fraud score assigned to the requested action is deny and delay action, the processor is configured to notify the network interface to accept any further requested actions submitted by the user before the fraud score for the requested action is received, delay performing the requested action until another fraud score is received, and, if the another fraud score is not received after a period of time greater than a deny and delay time threshold, the processor applies a final status of rejected to the requested action such that the requested action is not performed.

Alternatively or additionally, the interface mode for processing the requested action is determined by the processor analyzing an action type of the requested action and a payment type of the requested action.

Alternatively or additionally, the system additionally includes a non-transitory computer readable medium storing an interface configuration table. The processor determines the interface mode of the requested action using the interface configuration table and the action type and/or the payment type.

Alternatively or additionally, the system further includes a non-transitory computer readable medium storing an interface configuration table. The processor determines the interface mode of the requested action using the interface configuration table.

Alternatively or additionally, the network interface receives multiple requested actions from the user over a period of time and the processor is further configured to generate a report listing the actions for which the network interface did not receive a fraud score.

Alternatively or additionally, the report additionally lists the requested actions initially having the synchronous mode that were subsequently changed to the asynchronous mode due to no fraud score being received by the network interface for the requested action before a period of time greater than the synchronized cutoff time threshold passed.

Alternatively or additionally, if the requested action is one action in a set of actions included in an imported file, then the processor assigns the interface mode for the requested action to be asynchronous mode and the asynchronous cutoff time threshold is extended to a file import timeout buffer that is greater than the asynchronous cutoff time threshold.

Alternatively or additionally, if the fraud score assigned to the requested action is deny action, the processor applies the final status of rejected to the requested action such that the requested action is not performed unless authorized by another user.

Alternatively or additionally, the requested action is related to a payment request and, if the fraud score assigned to the requested action is block action, the processor applies the final status of rejected to the related payment request such that the related payment request is not advanced for payment processing.

Alternatively or additionally, the requested action is related to a payment request, payment requests are released to a financial institution or a clearing system at a payment release time, and a cutoff release threshold is a period of time prior to the payment release time In which users are not permitted to send new requested actions. If the fraud score assigned to the requested action is allow and delay action, another fraud score is not received, and the cutoff release threshold has been exceeded, the processor enables the requested action to be performed. If the fraud score assigned to the requested action is deny and delay action, another fraud score is not received, and the cutoff release threshold has been exceeded, the processor applies a final status of rejected to the requested action such that the requested action is not performed.

A number of features are described herein with respect to embodiments of this disclosure. Features described with respect to a given embodiment also may be employed in connection with other embodiments.

For a better understanding of the present disclosure, together with other and further aspects thereof, reference is made to the following description, taken in conjunction with the accompanying drawings. The scope of the disclosure is set forth in the appended claims, which set forth in detail certain illustrative embodiments. These embodiments are indicative, however, of but a few of the various ways in which the principles of the disclosure may be employed.

### BRIEF DESCRIPTION OF THE DRAWINGS

FIG. 1 is a block diagram representing the architecture of a payment processing system including a payment processing server.

FIGS. 2A-2E are flow diagrams representing operation of the fraud scoring method.

### DETAILED DESCRIPTION OF THE INVENTION

The present invention is now described in detail with reference to the drawings. In the drawings, each element with a reference number is similar to other elements with the same reference number independent of any letter designation following the reference number. In the text, a reference number with a specific letter designation following the reference number refers to the specific element with the number and letter designation and a reference number without a specific letter designation refers to all elements with the same reference number independent of any letter designation following the reference number in the drawings.

It should be appreciated that many of the elements discussed in this specification may be implemented in a hardware circuit(s), a processor executing software code or instructions which are encoded within computer readable media accessible to the processor, or a combination of a hardware circuit(s) and a processor or control block of an integrated circuit executing machine readable code encoded within a computer readable media. As such, the term circuit, module, server, application, or other equivalent description of an element as used throughout this specification is, unless otherwise indicated, intended to encompass a hardware circuit (whether discrete elements or an integrated circuit block), a processor or control block executing code encoded in a computer readable media, or a combination of a hardware circuit(s) and a processor and/or control block executing such code.

The present disclosure provides a payment processing system for verifying a requested action for payment processing. Before executing the requested action, the system sends a request for a fraud score and determines an interface mode of the requested action. The system processes the requested action according to the determined interface mode and, if received, a fraud score for the requested action.

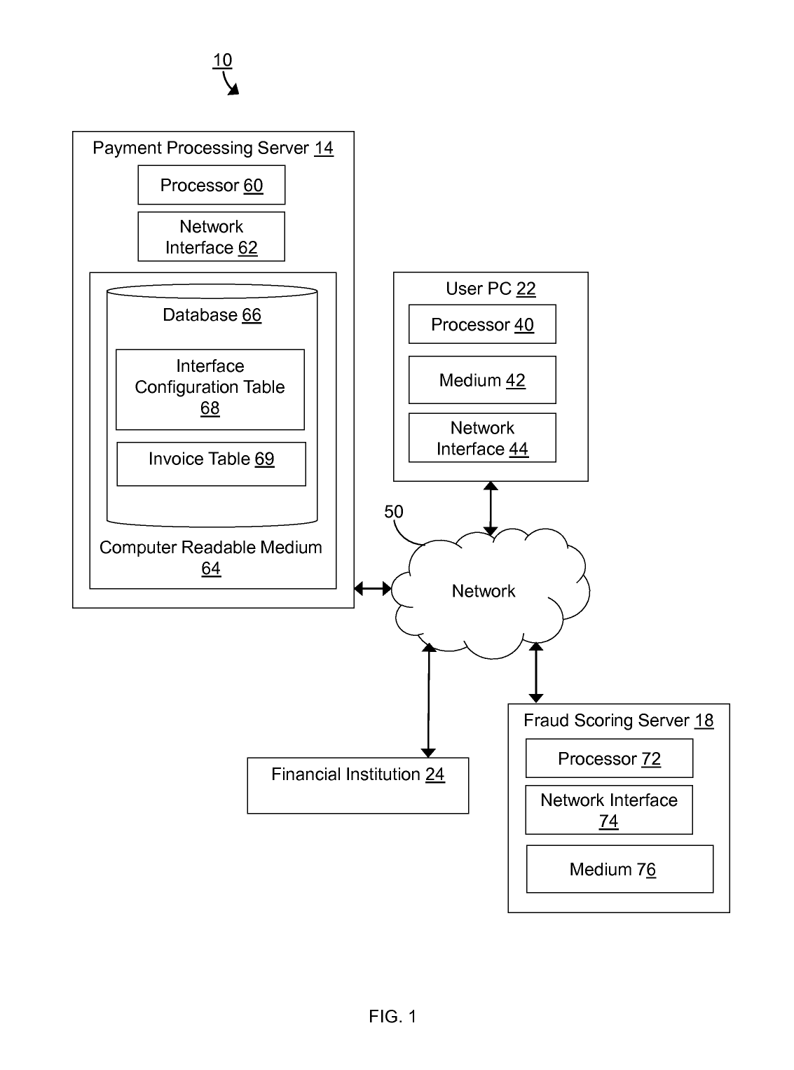

An exemplary payment processing system 10 including a payment processing server 14 is depicted in FIG. 1. The exemplary payment processing system 10 may also include a fraud scoring server 18, a user personal computer (PC) 22, and a financial institution 24. The payment processing server 14 receives requested actions from users of the system 10. For example, a user of the user PC 22 may request an action paying a specified vendor from a bank account held in the financial institution 24. In another example, a user of the user PC 22 may request an action that is related to a payment request. For example, a user of the user PC 22 may request changing the payee's address for an already schedule payment. The requested action may be transferred via a network 50 to the payment processing server 14. Prior to performing the requested action, the payment processing server 14 requests a fraud score from the fraud scoring server 18 to determine if the requested action is (or appears to be) fraudulent. The fraud scoring server 18 analyzes, e.g., information on the user requesting the action, information on the payor, the requested action details, historical payments made by the payee to the payor, historical data for the requesting user, historical data for the payor, recent actions requested by the requesting user, etc. Based on this information, the fraud scoring server 18 determines if the requested action appears to be fraudulent or valid and passes a fraud score to the payment processing server 14.

A corporate customer may have an account with the payment processing system 10 and a financial institution 24. The corporate customer may have multiple users with varying levels of permission to request different actions regarding different accounts held by the corporate customer at the financial institution 24. This information may be stored on the payment processing server 14, an entitlement server (not shown), or another server or device. A user associated with the corporate customer may access the payment processing server 14 via a PC 22. As will be understood by one of ordinary skill in the art, the PC 22 may be a mobile device, smart phone, computer, tablet, or any other suitable device. For example, the user PC 22 may include a processor 40, computer readable medium 42, and network interface 44 for providing a requested action to the payment processing server 14 via the network 50.

With continued reference to FIG. 1, the payment processing server 14 may be a computer system of one or more servers comprising at least a processor 60, a network interface 62, and computer readable medium 64. The computer readable medium 64 may include encoded thereon instructions embodied on the computer readable medium 64 for interfacing with the network interface 62 and reading and writing data to the computer readable medium 64. The computer readable medium 64 may also include computer programs comprising instructions embodied on the computer readable medium 64 that are executed by the processor 60.

As will be understood by one of ordinary skill in the art, the processor 60 may have various implementations. For example, the processor 60 may include any suitable device, such as a programmable circuit, integrated circuit, memory and I/O circuits, an application specific integrated circuit, microcontroller, complex programmable logic device, other programmable circuits, or the like. The processor 60 may also include a non-transitory computer readable medium, such as random access memory (RAM), a read-only memory (ROM), an erasable programmable read-only memory (EPROM or Flash memory), or any other suitable medium. Instructions for performing the method described below may be stored in the non-transitory computer readable medium and executed by the processor. The processor 60 may be communicatively coupled to the computer readable medium 64 and network interface 62 through a system bus, mother board, or using any other suitable structure known in the art.

The network interface 62 of the payment processing server 14 may be communicatively coupled to one or more users PC's 22, the financial institution 24, and a fraud scoring server 18 via a network 50. The network 50 may be an open network, such as the Internet, a private network, such as a virtual private network, or any other suitable network. The network interface 62 may be configured to receive at least one requested action from the user. The requested action may be an electronic file including information regarding the requesting user, a description of the action requested, a payee, a payor, a bank account, and/or containing any other suitable information needed by the payment processing server 14 to perform the action or for the fraud scoring server 18 to provide a fraud score to the payment processing server 14. Upon receiving a requested action, the network interface 62 is configured to send a request for a fraud score for the requested action, e.g., to the fraud scoring server 18.

As will be understood by one of ordinary skill in the art, the network interface 62 may comprise a wireless network adaptor, an Ethernet network card, or any suitable device that provides an interface between the payments processing server 14 and the network 50. The network interface 62 may be communicatively coupled to the computer readable medium 64, such that the network interface 62 is able to send data stored on the computer readable medium 64 across the network 60 and store received data on the computer readable medium 64. The network interface 62 may also be communicatively coupled to the processor 50 such that the processor is able to control operation of the network interface 62. The network interface 62, computer readable medium 64, and processor 60 may be communicatively coupled through a system bus, mother board, or using any other suitable manner as will be understood by one of ordinary skill in the art.

The fraud scoring server 18 may be operated by a third party separate from the payment processing server 14 and the financial institution 24 and may include at least one computer system or server. The fraud scoring server 18 provides a fraud score for a requested action. The fraud scoring server 18 includes a processor 72, a network interface 74, and a non-transitory computer readable medium 76.

The fraud scoring server 18 receives the request for a fraud score from the payment processing server 14. The request for a fraud score may include information regarding the requested action, identification of the requesting user, historical data for the user, historical data for the payee, historical data for the payor, and/or any other available data suitable for use to determine the validity of an action request. The processor 72 analyzes the request for a fraud score and/or determines a fraud score to report back to the payment processing server 14 via a network interface 74. The processor 72 may utilize data included in the non-transitory computer readable medium 76 to determine the fraud score. The fraud score may be an allow action, a block action, a deny action, a challenge action, a delay action, an allow and delay action, or a deny and delay action.

After sending the request for a fraud score for the requested action, the network interface 62 of the payment processing server 14 may not immediately receive a fraud score. For example, a fraud score may not be received for the requested action for a duration of time (e.g., more than 15 minutes). The delay in receiving the fraud score may be due to a delay or malfunction in the fraud scoring server. For example the fraud scoring server 18 may receive a large number of requests during a short period of time, causing the fraud scoring server 18 to delay in sending a fraud score. If the payment processing server 14 receives a fraud score for the requested action, the network interface 62 may be configured to notify the processor 60 when the fraud score for the requested action is received.

For each received requested action, the processor 60 of the payment processing server 14 analyzes the requested action to determine a mode of an interface for processing the requested action. The interface mode may be either synchronous mode or asynchronous mode. The interface mode for processing the requested action may be determined by analyzing an action type of the requested action and/or a payment type of the requested action.

The payment type may be defined by the financial institution 24. For example, the payment type may be CHAPS, BAGS, faster payment, Federal Wire, payroll, ACH, or any other suitable payment type designation.

The action type of the requested action may be broadly classified as either a payment action or a template action. A payment action may include submission of the payment, bulk submission of payments, setting a payment as a draft, modifying a payment, approving a payment, submitting an auto approving payment, rejection of a payment by an approver, payment approval, deleting payments, quick entry of multiple payments at a time, and payment file upload.

A template action may include submission of a template, saving a template as a draft, modifying a template, approving a template, submitting an auto approving a template, rejection of a template by an approver, template un-approve, template delete, and template file upload. A payment action and a template action may identify a payee, a payor, a payee account number, a payor account number, associated routing information, a related invoice number, and any other suitable information for performing the requested action.

As described above, the interface mode for processing a requested action may be determined by analyzing the action type of the requested action. In one embodiment, the payment processing server 14 may receive from the financial institution 24 an interface configuration table. The payment processing server 14 may store the interface configuration table on the non-transitory computer readable medium 76. The interface configuration table may set forth the interface mode for processing each specific action type for requested actions affecting accounts held by the financial institution 24. The interface configuration table may allow each financial institution to balance fraud risk with user experience and payment processing efficiencies in a manner that meets their risk manager profiles and mandates as well as the capabilities of the fraud scoring server 18. The processor 60 may determine the interface mode of the requested action using the interface configuration table.

In one embodiment, the interface configuration table for the financial institution 24 may select any of the above described template actions, except the template file upload, to be processed (at least initially) using either the asynchronous mode or the synchronous mode. In this embodiment, the template file upload may only be processed using the asynchronous mode. Similarly, the interface configuration table for the financial institution 24 may select any of the above described payment actions, except the quick entry of multiple periods of time and payment file upload, to be processed (at least initially) using either the synchronous mode or asynchronous mode. The quick entry of multiple periods of time and payment file upload may only be processed using the asynchronous mode in this embodiment. In this embodiment, the interface mode for a requested action may default to synchronous mode whenever the requested action is capable of being processed using both the asynchronous mode and synchronous mode.

The processor 60 is configured to process a requested action based on the interface mode of the requested action. If the interface mode of the requested action is synchronous mode, the processor 60 is configured to notify the network interface 62 to refuse to accept further requested actions from the user until the fraud score for the requested action is received. If no fraud score is received by the network interface 62 after period of time greater than a synchronized cutoff time threshold, the processor is further configured to change the interface mode for the requested action to asynchronous mode or to assign the fraud score of the requested action to be allow and delay action or deny and delay action. The synchronized cutoff time threshold may be 5000 seconds, 1000 seconds, 250 seconds, 60 seconds, 30 seconds, 10 seconds, or any other suitable duration of time.

The processor 60 may determine whether to change the interface mode for the requested action to asynchronous mode or to assign the fraud score of the requested action to be allow and delay action or deny and delay action using the interface configuration table. For example, to minimize the risk of executing a fraudulent requested action, the interface configuration table may specify assigning the requested action a deny and delay fraud score. Alternatively, the processor 60 may utilize a system default value instead of using the interface configuration table. As will be understood by one of ordinary skill in the art, the processor 60 may utilize any suitable means for determining whether to change the interface mode for the requested action to asynchronous mode or to assign the fraud score of the requested action to be allow and delay action or deny and delay action.

If the interface mode of the requested action is asynchronous mode, the processor 60 is configured to notify the network interface 62 to accept further requested action submitted by the user before the fraud score for the requested action is received. If no fraud score is received after a period of time greater than an asynchronous cutoff time threshold, the processor 60 is configured to assign the requested action an asynchronous default fraud score. The asynchronous cutoff time threshold may be 30 minutes, 15 minutes, 10 minutes, 5 minutes, 1 minute, or any other suitable duration of time. The asynchronous default fraud score may be allow action, block action, deny action, allow and delay action, the deny and delay action, or challenge action. The fraud score selected as the asynchronous default fraud score may be set by an administrator of the payment processing server 14 or the interface configuration table determined by the financial institution 24. For example, the financial institution 24 may set the asynchronous default fraud score to be block action to reduce the risk that a fraudulent requested action is performed. Alternatively, the financial institution 24 may set the asynchronous default fraud score to be allow action in order to prevent valid requested actions from being delayed, while increasing the risk that fraudulent requested actions will be performed. The financial institution 24 may also choose some other fraud score as the asynchronous default fraud score in order to balance the risk of performing fraudulent required actions with the risk of delaying valid requested actions.

In one embodiment, if the requested action is one action in a set of actions included in an imported file, then the interface mode for the requested action is set to be asynchronous mode and the asynchronous cutoff time threshold is extended to a file import timeout buffer that is greater than the asynchronous cutoff time threshold. For example, the file import timeout buffer may be 1 hour when the asynchronous cutoff time threshold is 15 minutes. Alternatively, e.g., the file import timeout buffer may be 2 hours, 90 minutes, or 45 minutes, 30 minutes, or any other suitable duration of time.

If the network interface receives a fraud score for the requested action, the processor is configured to assign the fraud score to the requested action. As described above, the received fraud score may be an allow action, a block action, a deny action, a challenge action, a delay action, an allow and delay action, or a deny and delay action.

If the fraud score assigned to the requested action is allow action, the processor enables the requested action to be performed. Enabling the requested action to be performed may include, e.g., the processor 60 performing the action, the financial institution 24 being notified by the payment processing server 14 to perform the requested action, or the payment processing server 14 notifying a third party to perform the requested action.

If the fraud score of the requested action is block action or deny action, the processor may apply a final status of rejected to the requested action such that the requested action is not performed. A requested action having a block action fraud score may be prevented from being performed by the processor 60 independent of future third-party action. For example, once a requested action regarding a payment request has received a block action fraud score, the payment request to which the requested action is related may be prevented from occurring independent of authorization by another party. The requested action receiving a deny action fraud score, however, may be prevented from being performed by the processor, e.g., unless or until another user authorizes the requested action. For example, if the requested action is to change the address of a payee for a pending payment request and the requested action receives a deny action fraud score, the related payment request may occur while the requested action is prevented unless the requested action is authorized by another user.

If the fraud score of the requested action is challenge action, the processor may notify the network 62 interface to request a new fraud score for the requested action. If the new fraud score is not received, the requested action may be assigned, e.g., a block action, a deny action, or an allow action. Alternatively, as opposed to requesting a new fraud score, the processor 60 may notify the network interface 62 to request further authentication from the user. For example, the user may be requested to verify their identity using a secondary means of authentication, such as entering a code sent to a mobile device. As will be understood by one of ordinary skill in the art, any secondary means of authentication suitable for verifying the identity of a user may be utilized. Based on the result of the secondary authentication, the payment processing system 10 or a third-party authentication system may set the fraud score or status of the requested action or related payment request. Alternatively, the payment processing system 10 may notify the fraud scoring server 18 of the secondary authentication result and then wait for a new fraud score from the fraud scoring server 18.

If the fraud score of the requested action is allow and delay action, the processor 60 may be configured to notify the network interface 62 to accept further requested action submitted by the user before the fraud score for the requested action is received. The processor may additionally be configured to delay performing the requested action until an additional fraud score is received. If the additional fraud score is not received after period of time greater than an allow and delay time threshold, the processor 60 may enable the requested action to be performed. The allow and delay time threshold may be 30 minutes, 15 minutes, 5 minutes, 1 minute, or any other suitable duration of time.

If the fraud score of the requested action is deny and delay action, the processor 60 may be configured to notify the network interface 62 to accept further requested action submitted by the user before the fraud score for the requested action is received. The processor may also be configured to delay performing the requested action until another fraud score is received. If the another fraud score is not received at a period of time greater than a deny and delay time threshold, the processor may apply a final status of rejected to the requested action such that the requested action is not performed. The deny and delay time threshold may be equal to the allow and delay time threshold. Alternatively, the deny and delay time threshold may be equal to 30 minutes, 15 minutes, 5 minutes, 1 minute, or any other suitable duration of time.

The network interface may receive multiple requested actions from a user over a period of time and the processor may be further configured to generate a report listing the actions for which the network interface did not receive a fraud score. The report may additionally list the requested actions initially having a synchronous mode that was subsequently changed to the asynchronous mode due to a fraud score not being received by the network interface 62 for the requested action before a period of time greater than the synchronized cutoff time threshold past.

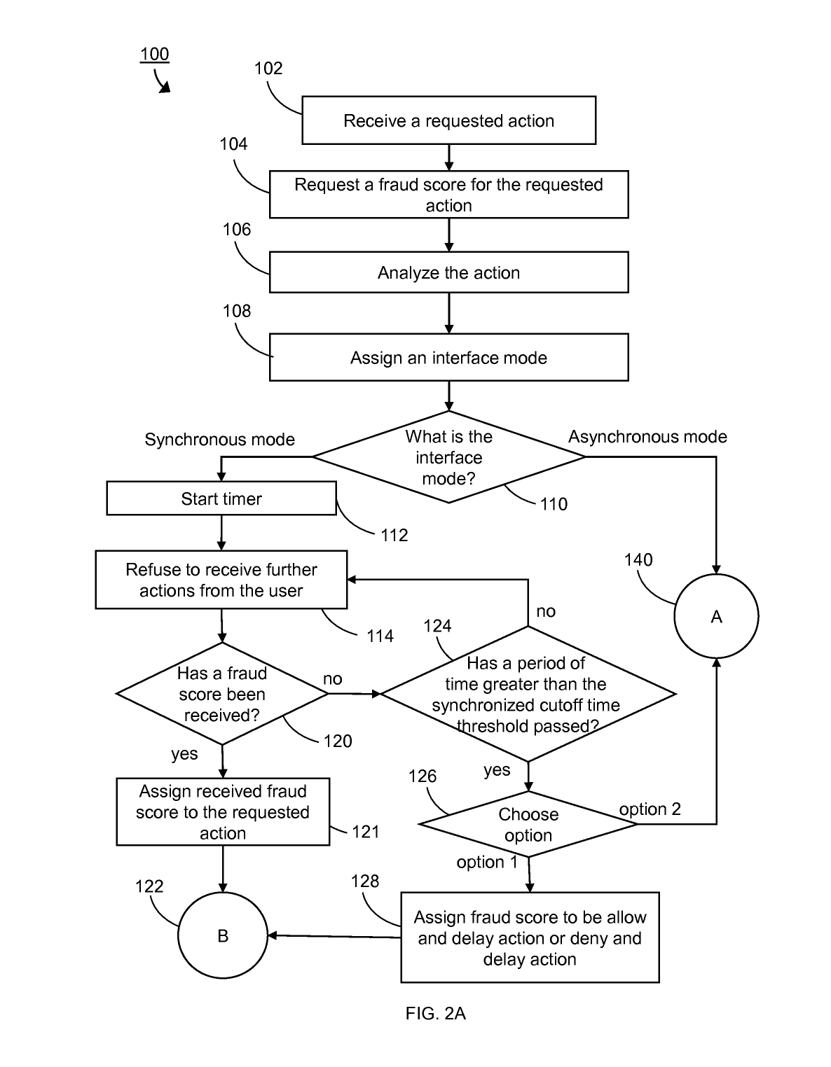

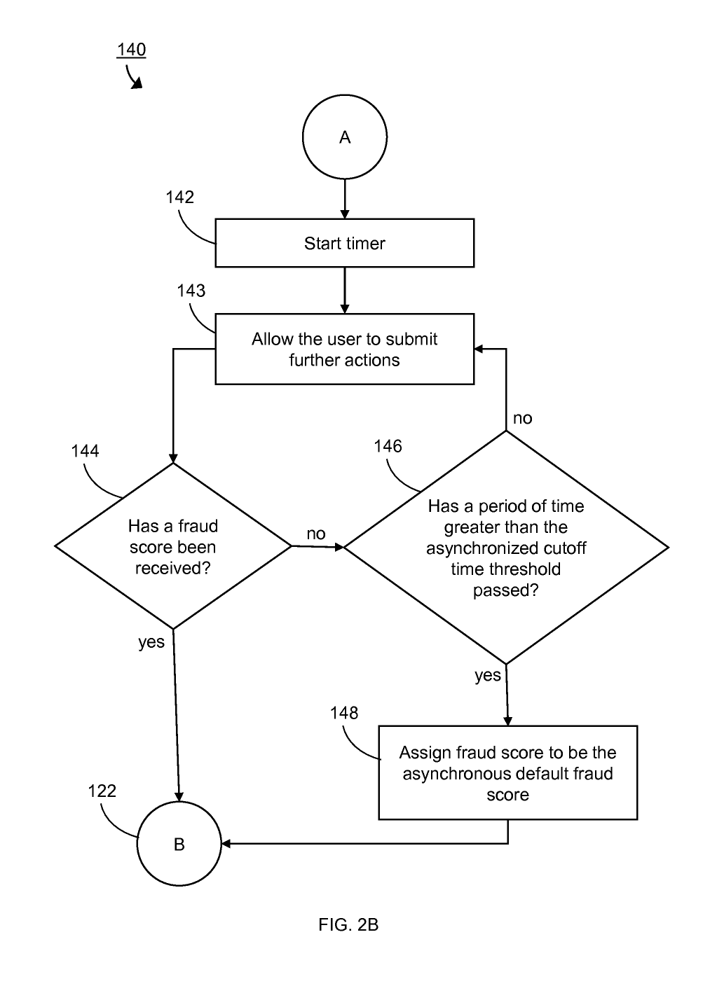

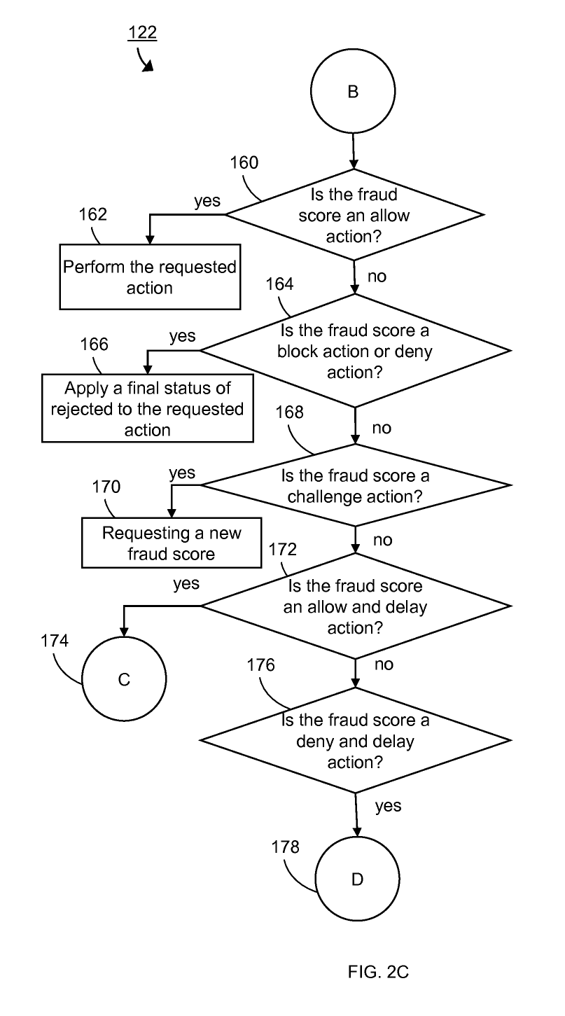

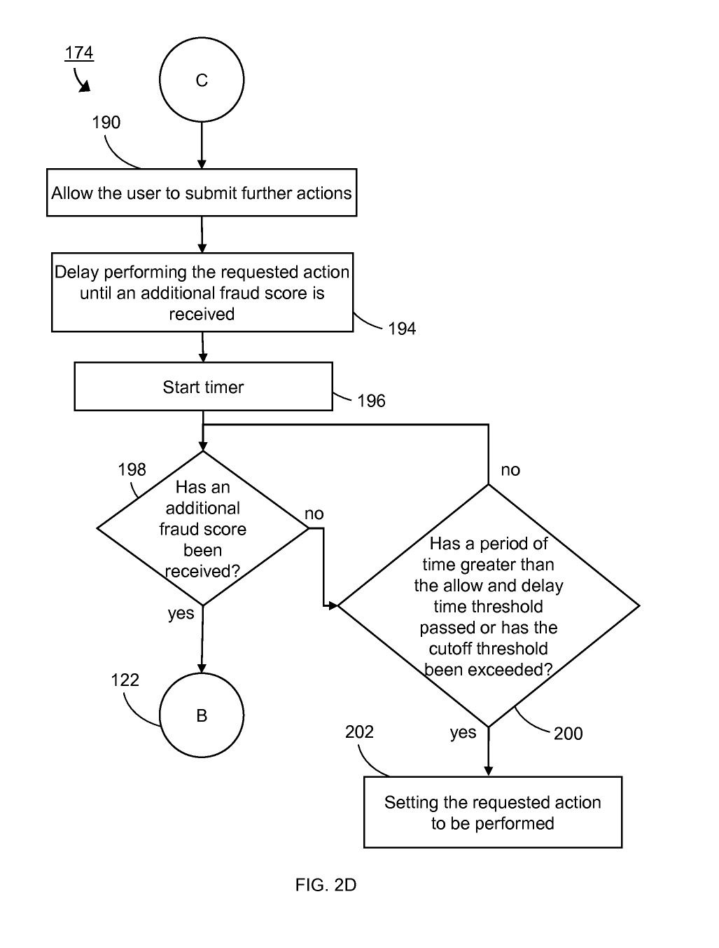

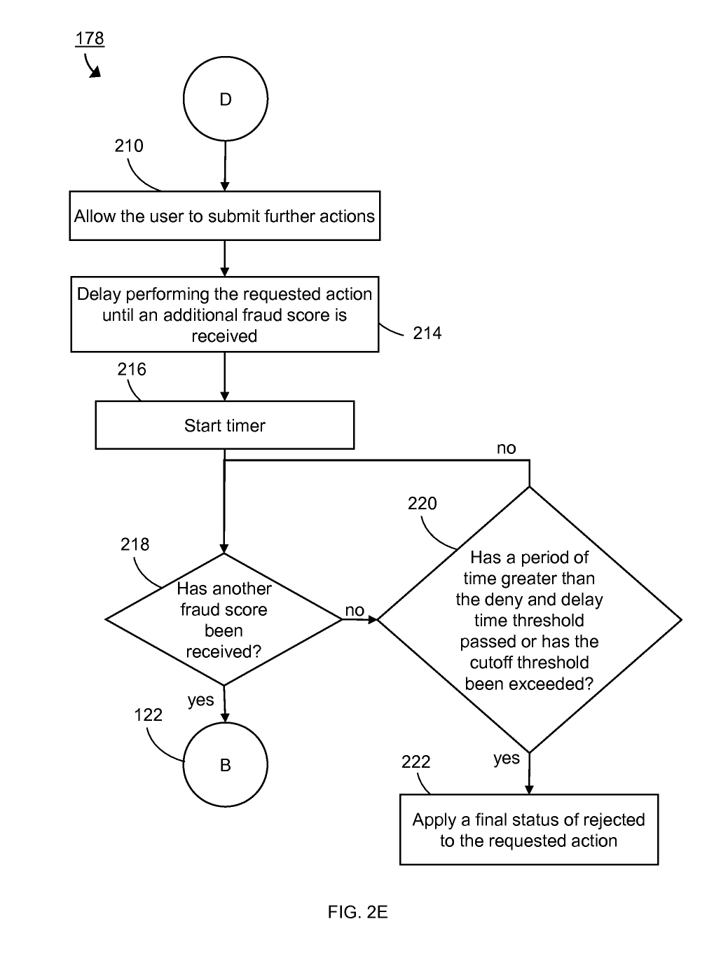

With reference to FIGS. 2A-2E, a block diagram is shown depicting a method 100 for verifying a requested action for payment processing and allowing management of fraud risk against transaction execution risk. The method may be performed using the processor 60 of the payment processing system 14.

Turning to FIG. 2A, a requested action is received from a user in processing block 102. The requested action may, e.g., be related to a payment request (e.g., updating the address of a payee, changing the date of payment, etc.) or the requested action may be a payment request itself. In processing block 104, a fraud score is requested for the requested action. In processing block 106, the requested action is analyzed, e.g., to determine whether the interface mode of the requested action is synchronous mode or asynchronous mode. In processing block 108, an interface mode is assigned to the requested action based on the analysis of the requested action. In decision block 110, processing of the requested action bifurcates depending on the mode of the requested action.

If the mode of the requested action is synchronous, a timer is started in processing block 112. In processing block 114, further requested actions from the user are refused until the fraud score for the requested action is received. In decision block 120, a check is made to determine if a fraud score has been received. If a fraud score for the requested action has been received, then the received fraud score is assigned to the requested action in processing block 121. If no fraud score has been received, then in processing block 124 a check is performed to determine if a period of time greater than a synchronized cutoff time threshold has passed. If a period of time greater than the synchronized cutoff time threshold has not passed, then processing returns to processing block 114.

If no fraud score is received after period of time greater than the synchronized cutoff time threshold, then processing moves to processing block 126 where a choice is made between option 1 and option 2. In option 2, the interface mode for the requested action is changed to asynchronous mode and processing moves to processing block 140 (shown in FIG. 2B). Alternatively, in option 1, the fraud score of the requested action is assigned to the allow and delay action or deny and delay action in processing block 128. Following step 128, processing continues in step 122 (as shown FIG. 2C). As described previously, a choice between option 1 and option 2 may be made based on the interface configuration table, a default setting, or using any other suitable means. Similarly in option 1, the choice between assigning an allow and delay fraud score or a deny and delay fraud score may be made based on the interface configuration table, a default setting, or using any other suitable means.

If the mode of the requested action is asynchronous mode, processing moves to processing block 140 shown in FIG. 2B. Turning to FIG. 2B, a timer is started in processing block 142. In processing block 143, the user is allowed to submit further requested actions before the fraud score for the requested action is received. In decision block 144, a check is performed to determine the fraud score has been received. If no fraud score has been received, a check is performed in decision block 146 to determine if a period of time greater than the asynchronous cutoff time threshold has passed. If a period of time greater than the asynchronous cutoff time threshold has not pass, processing returns to processing block 143. If no fraud score is received after a period of time greater than the asynchronous cutoff time threshold, the fraud score of the requested action is assigned to be the asynchronous default fraud score in processing block 148. Following processing block 148, the method moves to processing block 122.

Turning to FIG. 2C, processing of requested actions having an assigned fraud score is described. In decision block 160, a check is performed to determine if the fraud score is an allow action. If the fraud score assigned to the requested action is an allow action, then the requested action is performed in processing block 162. In decision block 164, a check is performed to determine if the fraud score assigned to the requested action is a block action or a deny action. In processing block 166, if the fraud score assigned to the requested action is a block action or deny action, a final status of rejected is applied to the requested action such that the requested action is not performed. As described previously, if the fraud score assigned to the requested action is deny action, the final status of rejected may be applied to the requested action such that the requested action is not performed unless authorized by another user. Alternatively, if the fraud score assigned to the requested action is block action, the final status of rejected is applied to a related payment request such that the related payment request is not advanced for payment processing. A payment request that is not advanced for payment processing may be prevented from occurring (i.e., the payment is never performed).

In processing block 168, a check is performed to determine if the fraud score is a challenge action. If the fraud score assigned to the requested action is a challenge action, a new fraud score for the requested action is requested in processing block 170. In decision block 172, a check is performed to determine if the fraud score for the requested action is allow and delay action. If the fraud score assigned to the requested action is allow and delay action, processing moves to processing block 174 (see FIG. 2D). In decision block 178, a check is performed to determine if the fraud score is a deny and delay action. If the fraud score assigned to the requested action is deny and delay action, processing moves to processing block 180 (see FIG. 2E).

FIG. 2D outlines the processing steps performed if the fraud score assigned to the requested action is allow and delay action. In processing block 190, the user is allowed to submit further requested actions before the fraud score for the requested action is received. In processing block 194, the requested action is delayed from being performed until an additional fraud score is received. A payment request related to the requested action may be delayed such that the release of payment from the payment processing system is delayed. In processing block 196 a timer is started. In decision block 198, a check is performed to determine if the additional fraud score has been received. If the additional fraud score has been received, processing moves to processing block 122. If an additional fraud score has not been received, a check is performed in decision block 200 to determine if a period of time greater than the allow delay time threshold has passed or if a cutoff release threshold has been exceeded. The cutoff release threshold is a period of time before payments are released, e.g., to the financial institution 24 or a clearing system. Users are not permitted to request actions during the cutoff release threshold that will progress payments. The cutoff threshold may differ depending on the payment type. If a period of time greater than the allow and delay time threshold has not passed, processing returns to step 198. In processing block 202, if the additional fraud score has not been received after a period of time greater than an allow and delay time threshold, the fraud score of the requested action is assigned to be the allow and delay default fraud score. Alternatively, if the additional fraud score has not been received and the cutoff release threshold has been exceeded, the fraud score of the requested action is assigned to be the cutoff release default fraud score in processing block 202. The allow and delay default fraud score and the cutoff release default fraud score may both set the requested action to be performed.

FIG. 2E outlines the processing steps performed if the fraud score assigned to the requested action is deny and delay action. In processing block 210, the user is allowed to submit further requested actions before the fraud score for the requested action is received. In processing block 214, the requested action is delayed from being performed until another fraud score is received. A timer is started in processing block 216 and a check is performed in decision block 218 to determine if the another fraud score has been received. If the another fraud score has been received, the method moves to processing block 122. If another fraud score has not been received, a check is performed in decision block 220 to determine if a period of time greater than the deny and delay time threshold has passed or if a cutoff release threshold has been exceeded. If a period of time greater than the deny and delay time threshold has not passed, processing returns to processing block 218. In processing block 222, if another fraud score is not received after period of time greater than the deny and delay time threshold, the fraud score of the requested action is assigned to be a deny and delay default fraud score. Alternatively, if the additional fraud score has not been received and the cutoff release threshold has been exceeded, the fraud score of the requested action is assigned to be the cutoff release default fraud score in processing block 202. The deny and delay default fraud score and the cutoff release default fraud score may both be a final status of rejected such that the requested action is not performed.

Although the invention has been shown and described with respect to certain exemplary embodiments, it is obvious that equivalents and modifications will occur to others skilled in the art upon the reading and understanding of the specification. It is envisioned that after reading and understanding the present invention those skilled in the art may envision other processing states, events, and processing steps to further the objectives of system of the present invention. The present invention includes all such equivalents and modifications, and is limited only by the scope of the following claims.

What is claimed is:

1. A fraud scoring method for verifying a requested action for payment processing and allowing management of fraud risk against transaction execution risk, the method comprising:
receiving the requested action from a user;
requesting a fraud score for the requested action, wherein the fraud score is allow action, block action, deny action, challenge action, allow and delay action, or deny and delay action;
assigning an interface mode for processing the requested action, wherein the interface mode is either synchronous mode or asynchronous mode and whether the interface mode is synchronous mode or asynchronous mode is determined by analyzing the requested action;
if the interface mode of the requested action is synchronous mode:
refusing to accept further requested actions from the user until the fraud score for the requested action is received; and
if no fraud score is received after a period of time greater than a synchronized cutoff time threshold, changing the interface mode for the requested action to asynchronous mode or assigning the fraud score of the requested action to be allow and delay action or deny and delay action;
if the interface mode of the requested action is asynchronous mode:
allowing the user to submit further requested actions before the fraud score for the requested action is received; and
if no fraud score is received after a period of time greater than an asynchronous cutoff time threshold, assigning the fraud score of the requested action to be an asynchronous default fraud score;
if the fraud score assigned to the requested action is allow action, then the requested action is performed;
if the fraud score assigned to the requested action is block action or deny action, applying a final status of rejected to the requested action such that the requested action is not performed;
if the fraud score assigned to the requested action is challenge action, requesting a new fraud score for the requested action;
if the fraud score assigned to the requested action is allow and delay action:
allowing the user to submit further requested actions before the fraud score for the requested action is received; and
delaying performing the requested action until an additional fraud score is received or, if no additional fraud score is received after a period of time greater than an allow and delay time threshold, setting the requested action to be performed; and
if the fraud score assigned to the requested action is deny and delay action:
allowing the user to submit further requested actions before the fraud score for the requested action is received; and
delaying performing the requested action until another fraud score is received or, if another fraud score is not received after a period of time greater than a deny and delay time threshold, applying a final status of rejected to the requested action such that the requested action is not performed.

2. The method of claim 1, wherein the interface mode for processing the requested action is determined by analyzing an action type of the requested action and a payment type of the requested action.

3. The method of claim 2, wherein the interface mode of the requested action is determined using an interface configuration table and the action type and/or the payment type.

4. The method of claim 2, wherein the action type is either a payment or a template.

5. The method of claim 2, wherein the payment type is either Faster Payment, Wire, CHAPS, BAGS, or file.

6. The method of claim 1, wherein the interface mode of the action is determined using an interface configuration table.

7. The method of claim 1, wherein the asynchronous default fraud score is allow action, block action, deny action, allow and delay action, deny and delay action, or challenge action.

8. The method of claim 1, wherein the delay default fraud score is allow action or block action.

9. The method of claim 1, wherein the synchronous cutoff time threshold is 5000 seconds.

10. The method of claim 1, wherein the asynchronous cutoff time threshold is 15 minutes and the delay cutoff timeout is 15 minutes or 30 minutes.

11. The method of claim 1, wherein, if the requested action is one action in a set of actions included in an imported file, then the interface mode for the requested action is set to be asynchronous mode and the asynchronous cutoff time threshold is extended to a file import timeout buffer that is greater than the asynchronous cutoff time threshold.

12. The method of claim 11, wherein the file import timeout buffer is one hour.

13. The method of claim 1, wherein if the fraud score assigned to the requested action is deny action, the final status of rejected is applied to the requested action such that the requested action is not performed unless authorized by another user.

14. The method of claim 1, wherein:
the requested action is related to a payment request; and
if the fraud score assigned to the requested action is block action, the final status of rejected is applied to the related payment request such that the related payment request is not advanced for payment processing.

15. The method of claim 1, wherein:
the requested action is related to a payment request;
payment requests are released to a financial institution or a clearing system at a payment release time;
a cutoff release threshold is a period of time prior to the payment release time In which users are not permitted to send new requested actions;
if the fraud score assigned to the requested action is allow and delay action, another fraud score is not received, and the cutoff release threshold has been exceeded, setting the requested action to be performed;
if the fraud score assigned to the requested action is deny and delay action, another fraud score is not received, and the cutoff release threshold has been exceeded, applying a final status of rejected to the requested action such that the requested action is not performed.

16. A payment processing system for verifying a requested action for payment processing and allowing management of fraud risk against transaction execution risk, the system comprising:
a processor and a network interface communicatively coupled;
the network interface configured to:
receive at least one requested action from a user; and
for each received requested action:
send a request for a fraud score for the requested action, wherein the fraud score is allow action, block action, deny action, challenge action, delay action, allow and delay action, or deny and delay action; and
when the fraud score for the requested action is received, notify the processor;
the processor configured to, for each received requested action:
assigning an interface mode for processing the requested action, wherein the interface mode is either synchronous mode or asynchronous mode and whether the interface mode is synchronous mode or asynchronous mode is determined by analyzing the requested action;
if the interface mode of the requested action is synchronous mode:
notify the network interface to refuse to accept further requested actions from the user until the fraud score for the requested action is received; and
if no fraud score is received by the network interface after a period of time greater than a synchronized cutoff time threshold, change the interface mode for the requested action to asynchronous mode or assign the fraud score of the requested action to be allow and delay action or deny and delay action;
if the interface mode of the requested action is asynchronous mode:
notify the network interface to accept further requested actions submitted by the user before the fraud score for the requested action is received; and
if no fraud score is received after a period of time greater than an asynchronous cutoff time threshold, assign the requested action an asynchronous default fraud score;
if the fraud score is received by the network interface for the requested action, assign the fraud score to the requested action;
if the fraud score assigned to the requested action is allow action, the processor enables the requested action to be performed;
if the fraud score assigned to the requested action is block action or deny action, the processor applies a final status of rejected to the requested action such that the requested action is not performed;
if the fraud score assigned to the requested action is challenge action, notify the network interface to request a new fraud score for the requested action;
if the fraud score assigned to the requested action is allow and delay action:
notify the network interface to accept any further requested actions submitted by the user before the fraud score for the requested action is received;
delay performing the requested action until an additional fraud score is received; and
if the additional fraud score is not received after a period of time greater than an allow and delay time threshold, the processor enables the requested action to be performed; and
if the fraud score assigned to the requested action is deny and delay action:
notify the network interface to accept any further requested actions submitted by the user before the fraud score for the requested action is received;
delay performing the requested action until another fraud score is received; and
if the another fraud score is not received after a period of time greater than a deny and delay time threshold, the processor applies a final status of rejected to the requested action such that the requested action is not performed.

17. The system of claim 16, wherein the interface mode for processing the requested action is determined by the processor analyzing an action type of the requested action and a payment type of the requested action.

18. The system of claim 17, further comprising a non-transitory computer readable medium storing an interface configuration table, wherein the processor determines the interface mode of the requested action using the interface configuration table and the action type and/or the payment type.

19. The system of claim 16, further comprising a non-transitory computer readable medium storing an interface configuration table, wherein the processor determines the interface mode of the requested action using the interface configuration table.

20. The system of claim 16, wherein the network interface receives multiple requested actions from the user over a period of time and the processor is further configured to generate a report listing the actions for which the network interface did not receive a fraud score.

21. The system of claim 20, wherein the report additionally lists the requested actions initially having the synchronous mode that were subsequently changed to the asynchronous mode due to no fraud score being received by the network interface for the requested action before a period of time greater than the synchronized cutoff time threshold passed.

22. The system of claim 16, wherein, if the requested action is one action in a set of actions included in an imported file, then the processor assigns the interface mode for the requested action to be asynchronous mode and the asynchronous cutoff time threshold is extended to a file import timeout buffer that is greater than the asynchronous cutoff time threshold.

23. The system of claim 16, wherein if the fraud score assigned to the requested action is deny action, the processor applies the final status of rejected to the requested action such that the requested action is not performed unless authorized by another user.

24. The system of claim 16, wherein:
the requested action is related to a payment request; and
if the fraud score assigned to the requested action is block action, the processor applies the final status of rejected to the related payment request such that the related payment request is not advanced for payment processing.

25. The system of claim 16, wherein:
the requested action is related to a payment request;
payment requests are released to a financial institution or a clearing system at a payment release time;
a cutoff release threshold is a period of time prior to the payment release time In which users are not permitted to send new requested actions;
if the fraud score assigned to the requested action is allow and delay action, another fraud score is not received, and the cutoff release threshold has been exceeded, the processor enables the requested action to be performed;
if the fraud score assigned to the requested action is deny and delay action, another fraud score is not received, and the cutoff release threshold has been exceeded, the processor applies a final status of rejected to the requested action such that the requested action is not performed.
